(19) United States
(12) Patent Application Publication
(10) Pub. No.: US 2026/0212034 A1
(43) Pub. Date: Jul. 23, 2026

(54) ADVANCED COMMERCE API

(71) Applicant: Apple Inc., Cupertino, CA (US)

(72) Inventors: Victoria L. Shurman, Santa Clara, CA (US); Fei Pan, Cupertino, CA (US); Gabriel F. Ting, Cupertino, CA (US)

(21) Appl. No.: 19/451,920

(22) Filed: Jan. 16, 2026

Related U.S. Application Data
(60) Provisional application No. 63/746,783, filed on Jan. 17, 2025.

(51) Int. Cl. G06F 21/62

(52) U.S. Cl. CPC G06F 21/6218

(57) ABSTRACT

Techniques for generating and utilizing a generic content identifier and corresponding data structure for requesting access to hosted digital content are described. A metadata payload is generated that identifies the digital content and the access for a user request. An access request data structure is generated using the generic content identifier and the metadata payload. The generic content identifier is transmitted to a host platform, which processes access request for generic content identifiers differently than for specific content identifiers. The generic content identifier is also associated with a second digital content for which access is requestable from the host platform.

### TECHNICAL FIELD

Embodiments described herein relate to software applications. More particularly, embodiments described herein relate to providing a mechanism for improving access requests to digital content from within an app.

### BACKGROUND

In recent years, downloading of software applications (or “apps”) from an on-line app store has become a popular method for obtaining software applications. An on-line app store allows users to download a software application onto their device, such as a desktop computer or laptop computer, smartphone, or other mobile device, and then install the app on their device. Prior to downloading an app, users often find apps within the app store. In response to a user search, the app store may provide results to the user with a particular set of representative data, such as an icon, screenshot, text description, and the like.

### BRIEF DESCRIPTION OF THE DRAWINGS

Embodiments described herein are illustrated by examples and not limitations in the accompanying drawings, in which like references indicate similar features. Furthermore, in the drawings, some conventional details have been omitted, so as not to obscure the inventive concepts described herein.

FIG. 1 illustrates, in block diagram form, network by which an app store is accessed by client devices, according to one or more embodiments.

FIG. 2 illustrates a flowchart of a technique for generating a generic content identifier, in accordance with one or more embodiments.

FIG. 3 illustrates a flowchart of a technique for processing access requests for generic and specific content identifiers, in accordance with one or more embodiments.

FIG. 4 illustrates a flowchart of a technique for processing an access request using a generic content identifier, in accordance with one or more embodiments.

FIGS. 5A-5B show example screenshots of a user interface for performing an access request, in accordance with one or more embodiments.

FIG. 6 illustrates a flowchart of a technique for updating commerce parameters using a generic content identifier, in accordance with one or more embodiments.

FIG. 7 illustrates a simplified functional block diagram of an illustrative programmable electronic device, in accordance with an embodiment.

### DETAILED DESCRIPTION

This disclosure pertains to systems, methods, and computer-readable media for providing a mechanism for implementing a general content identifier. In particular, embodiments described herein relate to a technique for providing an application programming interface (API) which allows a single SKU or other content identifier to be used to identify multiple types of digital content, or combinations of digital content.

Digital commerce platforms use content identifiers, such as Stock Keeping Units (SKUs), to manage content hosted by the platform and made available for access, such as a set of media items, subscription types, or the like. For each item or subscription offered within an application, a different content identifier may be used. This approach can be cumbersome and inefficient, particularly for developers with extensive or dynamic catalogs.

To address these challenges, the disclosed techniques provide a mechanism for utilizing a generic content identifier that can represent multiple types of digital content or combinations thereof. Rather than requiring a unique SKU for each item, the system enables developers to define a single, generic identifier that can be used in conjunction with other metadata to represent multiple offerings. At the time of a transaction, the developer supplies the additional metadata as payload with the generic identifier. The additional metadata may specify commerce parameters such as the specific content being purchased, pricing, descriptive information, and the like. This payload is transmitted as part of the purchase request, allowing the commerce platform to dynamically interpret and process the transaction based on the developer-supplied details. In doing so, the source of truth for the catalog is shifted from the distribution platform to the developer, enabling greater flexibility for developer offerings.

According to some embodiments, the digital distribution platform distinguishes between a standard content identifier and a generic content identifier. Whereas a standard content identifier may correspond one-to-one with a product or service listed in a distribution platform side catalog, a generic content identifier may be reused across multiple products or offerings. According to some embodiments, the distribution platform can detect that the content identifier is a generic content identifier based on an indication within the identifier, such as a generic flag sometime which may be maintained by the distribution platform. When a content identifier having a generic flag is used in an access request, the distribution platform processes that request differently, for example by analyzing the attached payload to determine what content is being requested.

A key technical improvement provided by this approach is the reduction of computational overhead associated with catalog management. By leveraging a generic SKU and dynamic metadata, the system reduces the need for developers to pre-register and maintain individual content identifiers. This solution enhances the scalability and adaptability of digital commerce systems, particularly for applications with rapidly changing or user-driven content offerings. By decoupling the catalog definition from the platform and enabling secure, dynamic content identification at the time of purchase, the disclosed techniques provide a robust and efficient framework for digital commerce.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flowchart may be presented in a particular order. However, it should be understood that the particular flow of any flow diagram is used only to exemplify one embodiment. In other embodiments, any of the various components depicted in the flowchart may be deleted, or the components may be performed in a different order, or even concurrently. In addition, other embodiments may include additional steps not depicted as part of the flowchart. The language used in this disclosure has been principally selected for readability and instructional purposes, and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming, but would nevertheless be a routine undertaking for those of ordinary skill in the art of image capture having the benefit of this disclosure.

### (a) Example Network Diagram

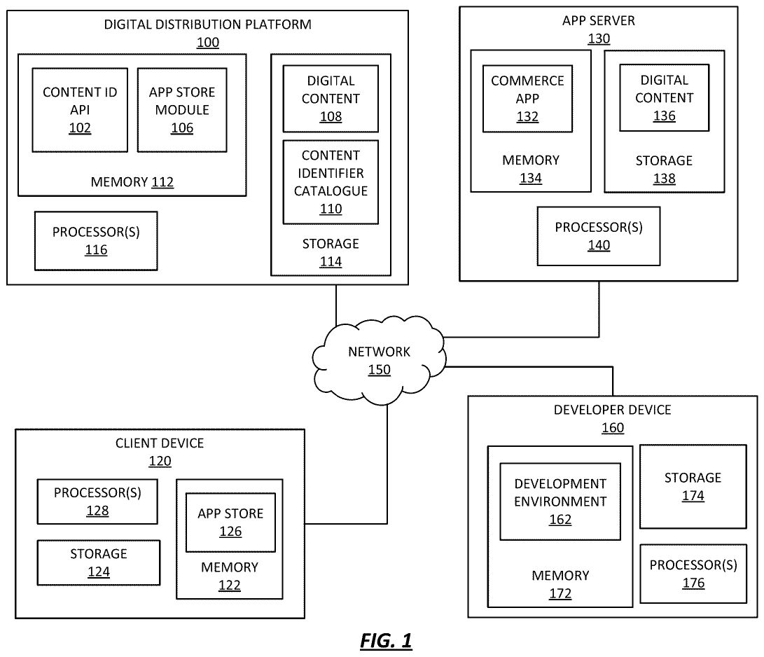

Embodiments described herein are directed to a technique for implementing a generic content identifier to use for multiple content types, in accordance with one or more embodiments. Referring to FIG. 1, a simplified block diagram is depicted of a digital distribution platform 100 connected to a client device 120, a developer device 160, and an app server 130, for example over a network 150. Client device 120 may be a multifunctional device, such as a mobile phone, tablet computer, personal digital assistant, portable music/video player, wearable device, or any other electronic device that is configured to provide access to apps and other digital content.

Digital distribution platform 100 may include one or more servers or other computing or storage devices on which the various modules and storage devices may be contained. Although digital distribution platform 100 is depicted as comprising various components in an exemplary manner, in one or more embodiments, the various components and functionality may be distributed across multiple network devices, such as servers, network storage, and the like. Further, additional components may be used, some combination of the functionality of any of the components may be combined.

Generally, digital distribution platform 100 may include one or more memory devices 112, one or more storage devices 114, and one or more processors 116, such as a central processing unit (CPU) or a graphical processing unit (GPU). Further processor 116 may include multiple processors of the same or different type. Memory 112 may each include one or more different types of memory, which may be used for performing device functions in conjunction with processor 116. For example, memory 112 may include cache, ROM, and/or RAM. Memory 112 may store various programming modules during execution, such as content ID API 102, and app store module 106.

According to one or more embodiments, digital distribution platform 100 may host digital content 108, which can be made available to user on devices such as client device 120. In addition, storage 114 may store additional data for the digital content, such as content identifier catalogue 110. Content identifier catalogue 110 may include content identifiers such as SKU's for the like by which particular content may be identified. In some embodiments, the content identifier catalogue may also include information regarding whether a particular content identifier is a generic or specific identifier. In some embodiments, a developer may register a content identifier as generic with the digital distribution platform 100 such that the digital distribution platform can track generic content identifiers. For example, the content identifier catalogue may include a generic flag for content identifiers that have been registered as generic.

In some embodiments, the digital content 108 may be hosted on behalf of developers who create the content. For example, the user at developer device 160 can generate an application, media item, or other digital content and make the content available on digital distribution platform 100. According to some embodiments, developer device 160 may include a processor 176, a memory 172, and a storage 174. In some embodiments, a user may use developer device 160 to generate digital content by way of development environment 162.

According to some embodiments, an application developed by a developer may be hosted on digital distribution platform 100, but may be associated with additional content on a third-party server, such as app server 130. App server 130 may be comprised of one or more computing devices, network storage, servers, or the like. App server 130 may include one or more processors 140, configured to execute instructions, such as commerce app 132 on memory 134. Commerce app 132 may be a computational module comprised of computer readable code executable by processor 140 to allow a user of an app to request access to additional content, such as through purchase or subscription, such as digital content 136 in storage 138. For example, commerce app 132 may enable access to digital content by a user of client device 120 executing the application. Client device 120 may include a processor 128 configured to execute computer readable code from memory 122. For example, memory 122 may include computer readable code for app store 126, which may be configured to generate access requests for digital content, for example from digital distribution platform 100 and/or app server 130.

In some embodiments, digital distribution platform 100 may allow the developer comments such as a user of developer device 160, to provide content identifiers for content being offered to users of the application. In some embodiments, each offering may be associated with a content specific identifier. According to one or more embodiments, the digital distribution platform 100 may provide a mechanism for reusing a content identifier for multiple products or groupings of products. For example, content ID API 102 may be used to register an SKU or other content identifier provided by a developer device 160 as a generic content identifier.

According to one or more embodiments, if a user, such as a user of client device 120, initiates an access request, the digital content, or other details about the access, maybe indicated in metadata provided along with a generic content identifier. Accordingly, the generic content identifier may be detected by the digital distribution platform 100, or app server 130, and used to identify the intended digital content. In addition, digital distribution platform 100 may be configured to translate the payload of the metadata into user interface component such that the user interface component on client device 120 identifies the specifics of the access.

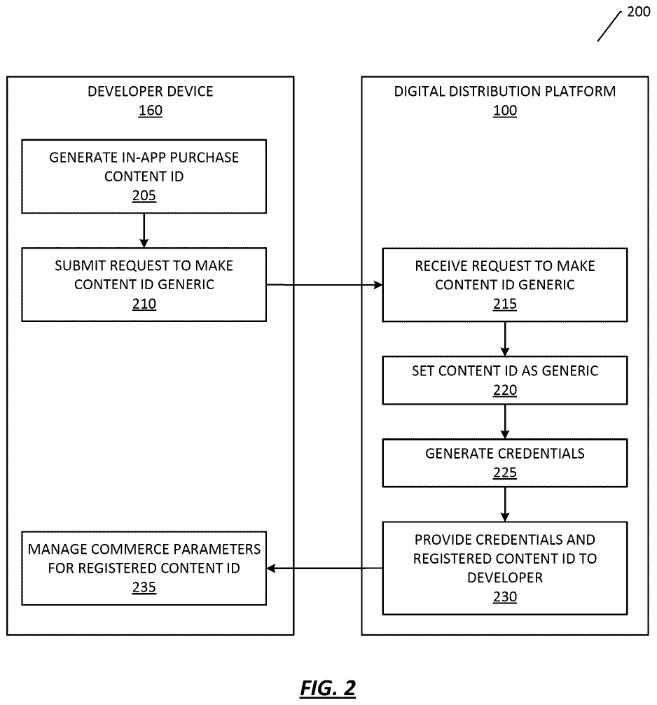

FIG. 2 is a flowchart of a method for generating a content identifier using the advanced commerce API, according to one embodiment. Although the various actions are depicted in a particular order, in some embodiments the various actions may be performed in a different order. In still other embodiments, two or more of the actions may occur simultaneously. According to yet other embodiments, some of the actions may not be required or other actions may be included. For purposes of clarity, the flowchart will be described with respect to the various components of FIG. 1. However, it should be understood that the various actions may be taken by alternative components, according to one or more embodiments.

The flowchart 200 begins at block 205, where the developer device 160 generates a content identifier for a digital item or a bundle of items that the developer wants to offer within an app, or alongside an app. The content identifier may represent the item or the bundle of items. In some embodiments, the content identifier may be an SKU or a character string.

At block 210, the developer device 160 submits a request to the digital distribution platform 100 to make the content identifier generic. By making the content identifier generic, the content identifier can be used to request access to any item or bundle of items that matches the metadata provided by the developer, without requiring the developer to create and register a separate content identifier for each item or bundle. This allows the developer to more easily manage a large catalog of items or bundles, and to dynamically change the content or the price of the items or bundles without affecting the content identifier.

The flowchart proceeds to block 215, where the Digital distribution platform 100 receives a request to make content identifier generic. In some embodiments, the request may be processed automatically, or may be at least partially driven by a person, such as an agent for the digital distribution platform. The request may be processed to ensure the request meets the eligibility requirements and the guidelines of the digital distribution platform 100, to ensure the developer has been approved to use a corresponding API, such as content ID API 102, or the like. The eligibility requirements and the guidelines may include, for example, the type and the size of the catalog, the business model, the app functionality, the app review, and the terms and conditions of the agreement.

The flowchart proceeds to block 220, where the digital distribution platform 100 registers the content identifier as generic and enables the API for the developer. The digital distribution platform 100 may store the content identifier and/or the associated metadata in a content identifier store 108, and may provide the developer with an access token or a key to use the advanced commerce API. In addition, the digital distribution platform 100 may store a generic flag in association with the content identifier such that the content identifier can be identified as generic when it is used.

At block 225, the digital distribution platform 100 generates credentials based on the generic content identifier. The credentials may be uniquely associated with the developer and the registered generic content identifier. This process may involve generating a private-public key pair, where the private key is securely provided to the developer and the public key is retained by the platform for subsequent verification of signed requests. The credentials are configured to enable secure access to the advanced commerce API, ensuring that only authorized developers can initiate commerce operations using the generic content identifier. The platform may also associate metadata with the credentials, such as expiration times, usage permissions, and scope of access, to further control and audit API usage. At block 230, the digital distribution platform 100 provides the credentials and registered content identifier to the developer.

The flow chart 200 concludes at block 235, where the developer device 160 manages commerce parameters for the registered generic content identifier. For example, the developer device 160 can process access requests from users using the application to dynamically identify what access is being requested. As another example, the developer device 160 can manage ongoing offerings, such as subscriptions, for which terms have changed.

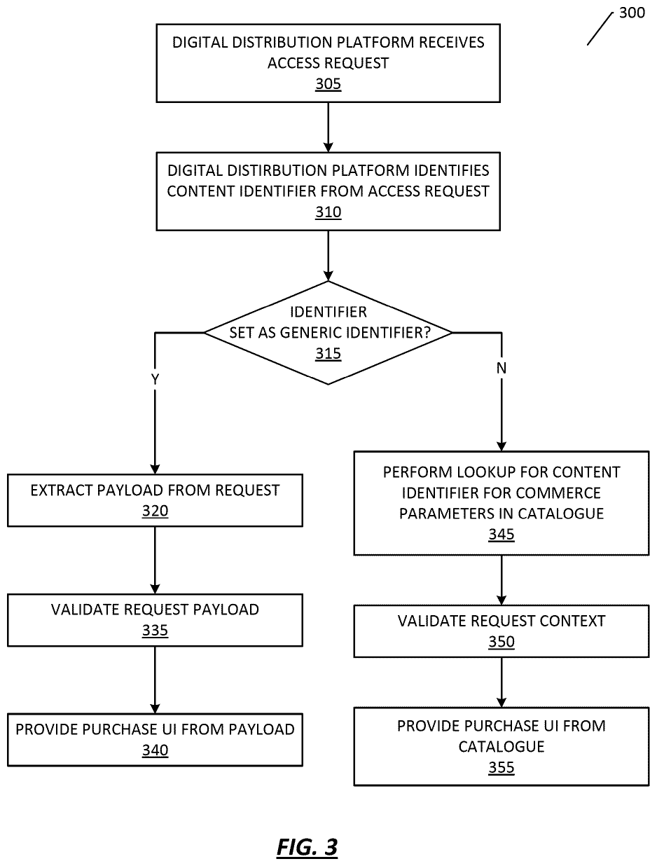

FIG. 3 illustrates a flowchart of a technique for processing access requests for generic and specific content identifiers, in accordance with one or more embodiments. Although the various actions are depicted in a particular order, in some embodiments the various actions may be performed in a different order. In still other embodiments, two or more of the actions may occur simultaneously. According to yet other embodiments, some of the actions may not be required or other actions may be included. For purposes of clarity, the flowchart will be described with respect to the various components of FIG. 1. However, it should be understood that the various actions may be taken by alternative components, according to one or more embodiments.

The flowchart begins at block 305, where the digital distribution platform receives the access request. According to one or more embodiments, the access request may originate from a user of a user device on which an application is operating. The access request may be an in-app request for particular content or services associated with the application and may be generated by a user interface of the application.

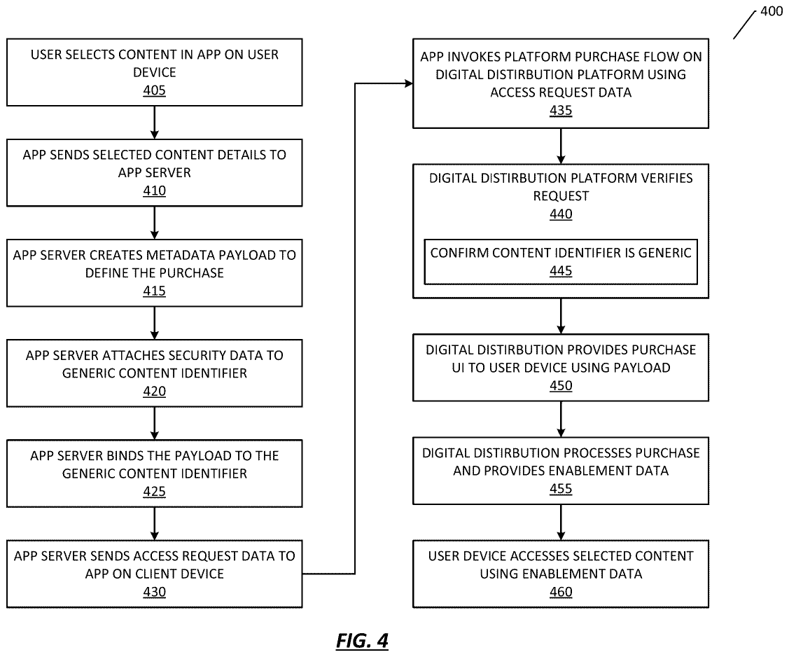

At block 310, the digital distribution platform identifies the content identifier from the access request. As will be described in greater detail with respect to FIG. 4, the access request submitted by the user device may include a content identifier. In some embodiments, the access request may be received in a particular data structure such that the digital distribution platform can extract the content identifier from the request.

The flowchart proceeds to block 315, where a determination is made as to whether the identifier identified at block 310 is set as a generic identifier. The digital distribution platform may be configured to process both generic and specific content identifiers. In some embodiments, the digital distribution platform may perform a lookup among registered content identifiers to determine whether a content identifier is generic. In some embodiments, the digital distribution platform may detect that the content identifier is a generic content identifier based on an indication within the identifier, such as a generic flag sometime which may be maintained by the distribution platform.

If a determination is made at block 315 that the identify as generic, then the flowchart 300 proceeds to block 320. At block 320, the distribution platform extracts the metadata payload from the request. As described above, the payload may include metadata that defines the access being requested. For example, the payload may indicate commerce parameters for the request, such as the particular content or service for which access is being requested. The flowchart 300 proceeds to block 335, where the distribution platform validates the requested payload. In some embodiments, validating the request may compare the commerce parameters to a rule set or parameters regarding the application and/or user to confirm access is allowable. Then, at block 340, the distribution platform provides a purchase user interface based on the payload. According to embodiments, the purchase interface may be provided as a window or content on the user device from which the user can complete the access request.

Returning to block 315, if a determination is made that the identifier is not set as generic, then the flowchart 300 proceeds to block 345, and the identifier is processed as a specific content identifier. At block 345, the distribution platform performs a lookup for content identifier for commerce parameters in a catalog. According to one or more embodiments, the distribution platform maintains a catalog of the content parameters associated with a unique identifier. This is distinct from the generic identifier which, in some embodiments, is associated with commerce parameters that are defined by the developer such as product details, price, and other parameters maintained by the platform. Accordingly, in some embodiments, the source of truth for content associated with specific content identifiers lies with the digital distribution, whereas the source of truth for content associated with generic content identifiers lies with the developer.

The flow chart 300 proceeds to block 350, where the distribution platform validates the requested context. For example, eligibility, availability, and consistency checks tied to the app, the user, and storefront constraints may be validated for the access request. The flow chart 300 concludes at block 355, where any purchase UI is provided to the user device based on the parameters indicated in the catalog. For example, a purchase flow may be initiated to provide a user interface to the user device with parameters indicated in the catalogue.

FIG. 4 illustrates a flowchart of a technique for processing an access request using a generic content identifier, in accordance with one or more embodiments. Although the various actions are depicted in a particular order, in some embodiments the various actions may be performed in a different order. In still other embodiments, two or more of the actions may occur simultaneously. According to yet other embodiments, some of the actions may not be required or other actions may be included. For purposes of clarity, the flowchart will be described with respect to the various components of FIG. 1. However, it should be understood that the various actions may be taken by alternative components, according to one or more embodiments.

The flowchart 400 begins at block 405, where an item or a bundle of items has been selected for access by a user within the app. The app may be running on a client device 120, such as a computer or a mobile device, that communicates with the app server 130 and the digital distribution platform 100 via the network 150. In some embodiments, the item or bundle of items may be the subject of an in-app purchase, and add-on item or companion item for an app, or the like.

At 410, the application from which the content is selected sends the content details to the app server 130. Then at block 415, the app server 130 creates a metadata payload that defines the access. The metadata payload may include information such as a description of the item or the bundle identifier, the name, the price, the currency, the tax code, the storefront, the app account token, the request reference identifier, the consistency token, and the like.

At block 420, the app server 130 attaches security data to the content identifier. The security data may include a signature, a certificate, or a token that verifies the authenticity and the integrity of the metadata payload. For example, in some embodiments, the app may obtain a digital key or key identifier and/or other security data such as a digital signature. The security data may be retrieved or fetched, for example, from a security server.

At 425, the app server 130 generates an access request using a generic content identifier and the metadata payload, for example by binding the payload to the generic content identifier. The generic identifier may be a predefined SKU or other identifier, such as a string of characters, which has been registered as a generic SKU. The access request may be formatted as a JSON Web Token (JWT) that encodes the metadata payload and the security data. Then, at block 430, the app server 130 sends the access request data to the app on the client device.

The flowchart 400 proceeds to block 435, where the application on the mobile device invokes a platform purchase flow on the digital distribution platform 100 using the access request data. The access request may be provided in the form of an access request data structure that includes the generic identifier and the metadata payload. The type of metadata included in the payload may vary based on type of request. For example, for subscription catalogues, the payload may include the following:
{descriptors.displayName}: The name of the subscription the customer is purchasing.
{items.displayName}: The tier of the subscription service the customer is purchasing, which should be different from your descriptors.displayName. For example, if an app includes creator subscriptions and a creator offers multiple subscription tiers, the displayName represents the tier being purchased.
{items.price}: The price of the item the customer is purchasing.
{period}: The duration of the subscription's billing cycle.
{currency}: The currency in which a customer is being charged.

As another example, bundled subscriptions may include the following:
{descriptors.displayName}: The name of the subscription SKU a customer is purchasing. This should represent overall subscription as well as be relevant for any combination of SKUs someone may choose to bundle.
{items.displayName}: The name of the add-on a customer is purchasing. For example, for a streaming app with multiple channel add-ons, this string could be “Live Sports”.
{items.price}: This is the price for each add-on within the bundled subscription purchase. When multiple bundle items are displayed, they may be sorted from highest to lowest in price.
{period}: The duration of the subscription's billing cycle.
{currency}: The currency in which a customer is being charged.

The format of the payload may vary depending on the transaction. An example for creating a subscription is as follows:

```
// Bold = required fields
{
  “operation”: “CREATE_SUBSCRIPTION”,
  “version”: “1”,
  “requestInfo”: {
    “appAccountToken”: “<UUID>”,
    “requestReferenceId”: “<UUID>”,
    “consistencyToken”: “<blob>”,
  },
  “currency”: “USD”,
  “taxCode”: “AZVR1”,
    “descriptors”: {
    “displayName”: “Plan Combination A”,
    “description”: “A plan comprising some
item(s)”,
},
“period”: “P1M”,
  “storefront”: “USA”,
  “previousTransactionId”: “1000”,
“items”: [
  {
    “SKU”: “BASE_PLAN_A”,
    “displayName”: “Subscription Base Plan”,
    “description”: “Monthly subscription service for base plan”,
    “price”: 9990,
    “offer”: {
      “price”: 3990,
      “period”: “P1M”,
      “periodCount”: 3,
      “reason”: “ACQUISITION”
    },
  },
  {
    “SKU”: “MGM_TV”,
    “displayName”: “Subscription Plan Name”,
    “description”: “Subscription Plan Description”,
    “price”: 3990,
    “offer”: {
        “price”: 2990,
        “period”: “P1M”,
        “periodCount”: 3,
        “reason”: “ACQUISITION”
      }
    }
  ]
}
```

Another example payload is as follows:

```
{
  “requestInfo”: {
    “appAccountToken”: “<UUID>”,
    “requestReferenceId”: “<UUID>”
    “consistencyToken”: “<blob>”
  }
  “storefront”: “USA”,
  // The targeted generic SKU
  “targetProductId”: “com.example.genericSKU”,
  “descriptors”: {
    “displayName”: “Media Provider A”,
    “description”: “Your streaming service”,
  },
  “items”: [
    {
      “SKU”: “MediaProviderA”,
      “displayName”: “Base Streaming Service”,
      “description”: “Monthly subscription service for base plan”,
    },
    ...
  ]
}
```

At block 440, the digital distribution platform verifies the request. According to one or more embodiments, the digital distribution platform extracts the security data from the access request. The security data may be extracted by decoding the JWT and verifying the signature, the certificate, or the token. The verification and the validation may include checking the authenticity and the integrity of the access request, the consistency and the accuracy of the metadata payload, and the like. According to one or more embodiments, verifying the request may include, at block 445, confirming that the content identifier extracted from the access request is generic.

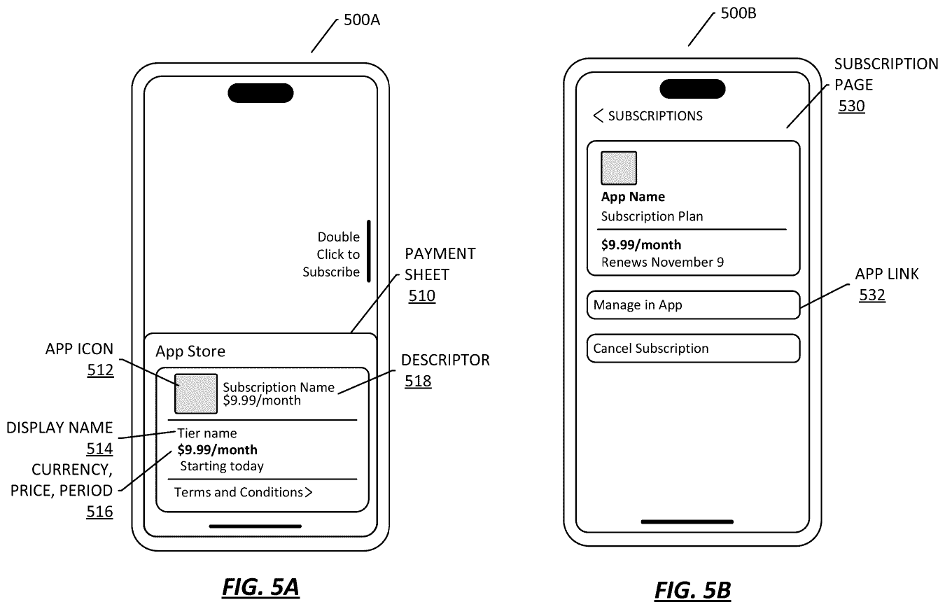

The flowchart 400 proceeds to block 450, where the digital distribution platform 100 processes the access request using the metadata payload and provides a purchase UI to the user device based on the payload. According to one or more embodiments, the purchase UI is generated based on the parameters of the metadata payload of the access request. Turning to FIG. 5A, an example interface on a user device 500A is shown. The interface includes a purchase UI in the form of payment sheet 510. The payment sheet 510 includes various parameters for the access, such as app icon 512, descriptor 518, display name, and currency price and period 516. According to some embodiment, one or more of these features of the payment sheet 510 may be derived from the metadata payload for the access request.

Returning to FIG. 4, at block 455, the digital distribution platform process the purchase and provides enablement data. The processing may include charging the user's payment method, applying the appropriate tax rate, updating the transaction history and/or the subscription status, and the like.

The flowchart 400 concludes at block 460, where the digital distribution platform 100 provides the receipt to the app server 130 and/or the client device 120. The receipt may include information such as the transaction identifier, the purchase date, the expiration date, the renewal date, the price, the currency, the tax amount, the storefront, and the advanced commerce information. The advanced commerce information may include the metadata payload and the security data that were used to process the access.

Turning to FIG. 5B, an example interface on a user device 500B is shown. The interface includes a subscription page 530, from which a user can manage the subscription obtained by the payment sheet 510 of FIG. 5A. The subscription page 530 may provide an interface from which a user can manage content obtained, for example, through in-app purchases. Thus, the subscription page includes various commerce parameters for the subscription. According to one or more embodiments, the subscription page 530 pay be a system-based subscription page separate from the application. Accordingly, the subscription page 530 may include an app link 532 by which the corresponding application can be accessed.

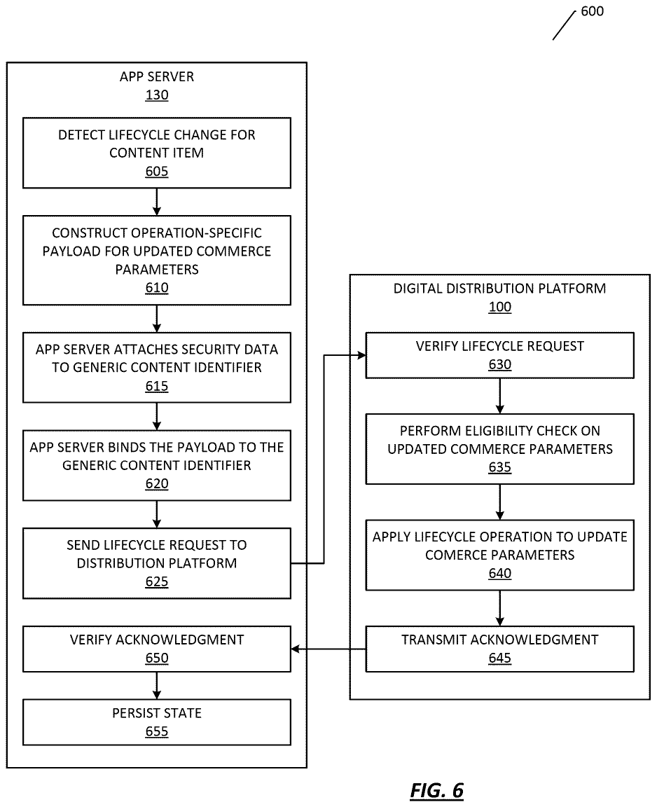

According to one or more embodiments, generic content identifiers can also be used for lifecycle operations related to content access. These lifecycle operations may include, for example, cancel, reactivate, refund, or modify a subscription. These operations may be performed through a server-to-server flow that does not involve an end user device UI. FIG. 6 illustrates a flowchart of a technique for updating commerce parameters using a generic content identifier, in accordance with one or more embodiments. Although the various actions are depicted in a particular order, in some embodiments the various actions may be performed in a different order. In still other embodiments, two or more of the actions may occur simultaneously. According to yet other embodiments, some of the actions may not be required or other actions may be included. For purposes of clarity, the flowchart will be described with respect to the various components of FIG. 1. However, it should be understood that the various actions may be taken by alternative components, according to one or more embodiments.

The flowchart 600 begins that block 605, where the app server detects a lifecycle change for the content item. In some embodiments, the developer's server determines that a lifecycle change is triggered. This may occur based on changes a developer may initiate after an initial purchase, for example regarding a change of terms to an ongoing subscription.

The flowchart 600 proceeds to block 610, where the app server 130 constructs an operation specific payload for updated commerce parameters. According to one or more embodiments, the operation specific payload carries the commerce parameters related to the lifecycle change that the platform would otherwise source from a platform-side catalog. The payload may include descriptors and commerce parameters such as display name, description, price, and period so the platform can properly interpret, apply, and reflect the change.

At block 615, the app server 130 attaches security data to the generic content identifier. For example, the developer may sign the payload using a private key so that the distribution platform can authenticate the requested operation and commerce parameters. Further, at block 620, the app server binds the payload to the generic content identifier. At block 625, a lifestyle request is sent to the distribution platform. In some embodiments, the developer device calls the content identifier API to execute the operation.

The flowchart 600 proceeds to block 630, where the digital distribution platform 100 receives and verifies the lifecycle request. In addition, the digital distribution platform 100 may recognize the content identifier as generic, thereby initiating a generic identifier workflow. At block 635, the digital distribution platform 100 performs an eligibility check on the updated commerce parameters from the lifecycle request. Then, at block 640, the digital distribution platform 100 applies the lifecycle operation to update parameters for the corresponding application.

At block 645, the digital distribution platform 100 transmits and acknowledgement regarding the life cycle request. The acknowledgment may indicate that the change has been applied. The flow chart 600 proceeds to block 650, where the app server verifies the acknowledgement. The flow chart concludes at block 655, where the app server persists the state of the lifecycle request. In doing so, the app server can maintain its own record of lifecycle changes applied by the distribution platform.

### (b) Example Electronic Device

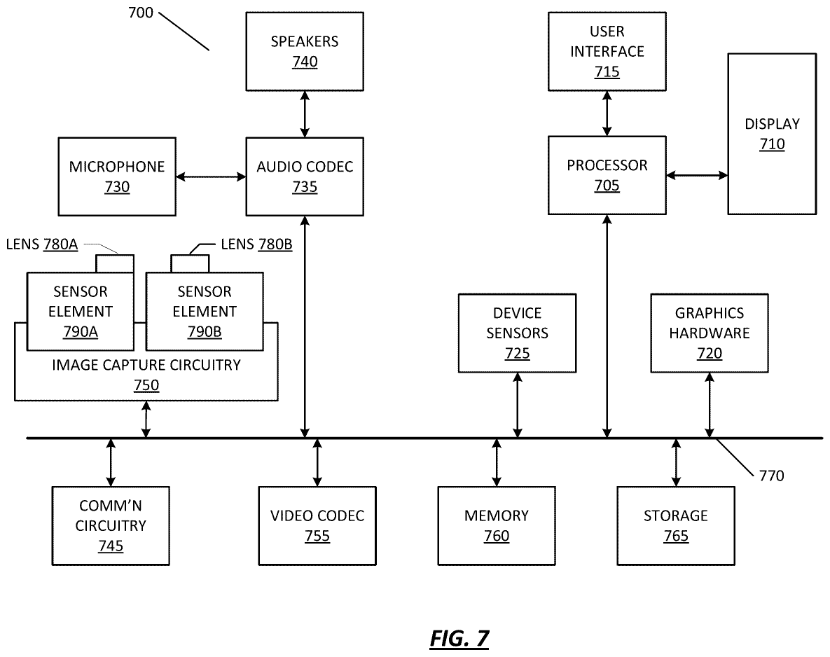

Referring now to FIG. 7, a simplified functional block diagram of an illustrative programmable electronic device 700 for providing access to an app store is shown, according to one embodiment. Electronic device 700 could be, for example, a mobile telephone, personal media device, portable camera, or a tablet, notebook or desktop computer system. As shown, electronic device 700 may include processor 705, display 710, user interface 715, graphics hardware 720, device sensors 725 (e.g., proximity sensor/ambient light sensor, accelerometer and/or gyroscope), microphone 730, audio codec(s) 735, speaker(s) 740, communications circuitry 745, image capture circuit or unit 750, which may, e.g., comprise multiple camera units/optical sensors having different characteristics (as well as camera units that are housed outside of, but in electronic communication with, device 700), video codec(s) 755, memory 760, storage 765, and communications bus 770.

Processor 705 may execute instructions necessary to carry out or control the operation of many functions performed by device 700 (e.g., such as the generation and/or processing of DAs in accordance with the various embodiments described herein). Processor 705 may, for instance, drive display 710 and receive user input from user interface 715. User interface 715 can take a variety of forms, such as a button, keypad, dial, a click wheel, keyboard, display screen and/or a touch screen. User interface 715 could, for example, be the conduit through which a user may view a captured video stream and/or indicate particular images(s) that the user would like to capture or share (e.g., by clicking on a physical or virtual button at the moment the desired image is being displayed on the device's display screen).

In one embodiment, display 710 may display a video stream as it is captured while processor 705 and/or graphics hardware 720 and/or image capture circuitry contemporaneously store the video stream (or individual image frames from the video stream) in memory 760 and/or storage 765. Processor 705 may be a system-on-chip such as those found in mobile devices and include one or more dedicated graphics processing units (GPUs). Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 perform computational tasks. In one embodiment, graphics hardware 720 may include one or more programmable graphics processing units (GPUs).

Image capture circuitry 750 may comprise one or more camera units configured to capture images, e.g., in accordance with this disclosure. Output from image capture circuitry 750 may be processed, at least in part, by video codec(s) 755 and/or processor 705 and/or graphics hardware 720, and/or a dedicated image processing unit incorporated within circuitry 750. Images so captured may be stored in memory 760 and/or storage 765. Memory 760 may include one or more different types of media used by processor 705, graphics hardware 720, and image capture circuitry 750 to perform device functions. For example, memory 760 may include memory cache, read-only memory (ROM), and/or random access memory (RAM). Storage 765 may store media (e.g., audio, image and video files), computer program instructions or software, preference information, device profile information, and any other suitable data. Storage 765 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 760 and storage 765 may be used to retain computer program instructions or code organized into one or more modules and written in any desired computer programming language. When executed by, for example, processor 705, such computer program code may implement one or more of the methods described herein. Power source 775 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 700.

In the foregoing description, numerous specific details are set forth, such as specific configurations, properties, and processes, etc., in order to provide a thorough understanding of the embodiments. In other instances, well-known processes and manufacturing techniques have not been described in particular detail in order to not unnecessarily obscure the embodiments. Reference throughout this specification to “one embodiment,” “an embodiment,” “another embodiment,” “other embodiments,” “some embodiments,” and their variations means that a particular feature, structure, configuration, or characteristic described in connection with the embodiment is included in at least one embodiment. Thus, the appearances of the phrase “for one embodiment,” “for an embodiment,” “for another embodiment,” “in other embodiments,” “in some embodiments,” or their variations in various places throughout this specification are not necessarily referring to the same embodiment. Furthermore, the particular features, structures, configurations, or characteristics may be combined in any suitable manner in one or more embodiments.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing system, that manipulates and transforms data represented as physical (electronic) quantities within the computer system's registers and memories into other data similarly represented as physical quantities within the computer system memories or registers or other such information storage, transmission or display devices.

Embodiments described herein can relate to an apparatus for performing a computer program (e.g., the operations described herein, etc.). Such a computer program may be stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

As used in the description above and the claims below, the phrases “at least one of A, B, or C” and “one or more of A, B, or C” include A alone, B alone, C alone, a combination of A and B, a combination of B and C, a combination of A and C, and a combination of A, B, and C. That is, the phrases “at least one of A, B, or C” and “one or more of A, B, or C” means A, B, C, or any combination thereof, such that one or more of a group of elements consisting of A, B and C, and should not be interpreted as requiring at least one of each of the listed elements A, B and C, regardless of whether A, B and C are related as categories or otherwise. Furthermore, the use of the article “a” or “the” in introducing an element should not be interpreted as being exclusive of a plurality of elements. Also, the recitation of “A, B, and/or C” is equal to “at least one of A, B, or C.” Also, the use of “a” refers to “one or more” in the present disclosure. For example, “a DA” refers to “one DA” or “a group of DAs.”

What is claimed is:

1. A method, comprising:
detecting an access request for a first digital content;
creating a metadata payload defining the first digital content;
generating an access request data structure using a generic content identifier and the metadata payload; and
transmitting the access request data structure to a distribution platform on which the first digital content is hosted,
wherein the generic content identifier is additionally associated with a second digital content hosted on the distribution platform.

2. The method of claim 1, wherein the access request data structure is processed based on the metadata payload in response to a determination that the access request data structure comprises the generic content identifier.

3. The method of claim 2, wherein processing the access request data structure causes the first digital content to be downloaded to an electronic device.

4. The method of claim 2, wherein processing the access request data structure causes the first digital content to be distributed to an electronic device.

5. The method of claim 1, wherein the first digital content comprises a bundle comprising a plurality of digital components.

6. The method of claim 5, wherein the metadata payload comprises an identifier for the plurality of digital components.

7. The method of claim 1, wherein the metadata payload comprises security data fetched from a security server.

8. A non-transitory computer readable medium comprising computer readable code executable by one or more processors to:
detect an access request for a first digital content;
create a metadata payload defining the first digital content;
generate an access request data structure using a generic content identifier and the metadata payload; and
transmit the access request data structure to a distribution platform on which the first digital content is hosted,
wherein the generic content identifier is additionally associated with a second digital content hosted on the distribution platform.

9. The non-transitory computer readable medium of claim 8, wherein the access request data structure is processed based on the metadata payload in response to a determination that the access request data structure comprises the generic content identifier.

10. The non-transitory computer readable medium of claim 9, wherein processing the access request data structure causes the first digital content to be downloaded to an electronic device.

11. The non-transitory computer readable medium of claim 9, wherein processing the access request data structure causes the first digital content to be distributed to an electronic device.

12. The non-transitory computer readable medium of claim 9, wherein the first digital content comprises a bundle comprising a plurality of digital components.

13. The non-transitory computer readable medium of claim 9, wherein the metadata comprises at least one selected from a group consisting of a specific content identifier, a display name, a description, and a period.

14. The non-transitory computer readable medium of claim 9, wherein the metadata payload comprises one or more commerce parameters.

15. The non-transitory computer readable medium of claim 14, wherein the one or more commerce parameters correspond to content data presented on a user interface for the first digital content.

16. A system comprising:
one or more processors; and
one or more computer readable media non-transitory computer readable medium comprising computer readable code executable by the one or more processors to:
detect an access request for a first digital content;
create a metadata payload defining the first digital content;
generate an access request data structure using a generic content identifier and the metadata payload; and
transmit the access request data structure to a distribution platform on which the first digital content is hosted,
wherein the generic content identifier is additionally associated with a second digital content hosted on the distribution platform.

17. The non-transitory computer readable medium of claim 16, wherein the access request data structure is processed based on the metadata payload in response to a determination that the access request data structure comprises the generic content identifier.

18. The non-transitory computer readable medium of claim 16, wherein the first digital content comprises a bundle comprising a plurality of digital components.

19. The non-transitory computer readable medium of claim 16, wherein the metadata payload comprises security data fetched from a security server.

20. The non-transitory computer readable medium of claim 16, wherein the metadata comprises at least one selected from a group consisting of a specific content identifier, a display name, a description, and a period.
